(19) United States
(12) Patent Application Publication
(10) Pub. No.: US 2023/0377119 A1
(43) Pub. Date: Nov. 23, 2023

(54) METHODS AND OPTICAL CHECKING UNITS FOR CHECKING A SIDE OF A FILM

(71) Applicant: Marposs Societa' Per Azioni, Bentivoglio (BO) (IT)

(72) Inventors: Umberto Calari, San Lazzaro Di Savena (BO) (IT); Francesco Forastieri, Ferrara (FE) (IT)

(21) Appl. No.: 18/031,248

(22) PCT Filed: Oct. 19, 2021
(86) PCT No.: PCT/EP2021/078921

§ 371 Date: Apr. 11, 2023

(30) Foreign Application Priority Data
Oct. 21, 2020 (IT) 102020000024796
Oct. 21, 2020 (IT) 102020000024799
Oct. 21, 2020 (IT) 102020000024808
Oct. 21, 2020 (IT) 102020000024811

(51) Int. Cl. G06T 7/00; H04N 23/90; G06T 7/90; H04N 23/56; G02B 21/36; G02B 21/00

(52) U.S. Cl. CPC G06T 7/0004; H04N 23/90; G06T 7/90; H04N 23/56; G02B 21/365; G02B 21/0016; G06T 2207/10016; G06T 2207/30136; G06T 2207/10024; G06T 2207/20021

(57) ABSTRACT

Optical checking unit (1) and method for checking a side (2) of a film (3) having a central metallic layer (4) and two insulating layers (5), which advances along a path (P). A camera (7) is provided next to the path to frame the side of the film through an optical system (8) and acquire a sequence of digital images (9). At least one lighting device (10) is configured to generate a light beam (11) which illuminates the side of the film. The light beam is partly reflected by at least one reflecting element (14) towards the optical system, and illuminates an area surrounding the side to be checked. The analysis of each digital image may involve: recognizing pieces of the central metal layer within the digital image based on values of the color components, and/or dividing the digital image into a succession of adjacent portions (19), determining the values of qualitative parameters in each portion and, by statistically processing such values, obtaining a summary value of the qualitative parameter for the entire digital image.

### TECHNICAL FIELD

The present invention relates to methods and optical checking units for checking a side of a film. The present invention finds advantageous application in the check of a side or edge (obtained by effect of a transversal cut) of a film intended for making an electrode (anode or cathode) of a battery, to which the following description will make explicit reference without thereby losing of generality.

### BACKGROUND ART

One of the fundamental components of a battery are the electrodes which, in order to minimize the size of the battery, are normally made up of a thin ribbon or film comprising a central metal layer (i.e. a layer made of an electrically conductive material such as copper or aluminium) enclosed between two external insulating layers (i.e. layers made of an electrically insulating material such as zinc oxide). The film is made starting from a large metal sheet which is initially coated on both sides with insulating material and is subsequently cut into strips to separate the ribbons or films.

Cutting the metal sheet is a critical operation, since if the knives that perform the cut are not correctly set or are worn, the cut can produce metal burrs on the two sides of the cut, and the metal burrs can break and cross the insulating layers. If the sides of a film have metal burrs, short circuits can easily be triggered in the battery between two adjacent electrodes and, in addition to degrading the performance of the battery, give rise to destructive phenomena of the battery.

In the production process of the films it is therefore known to carry out sample checks of the sides of the films in such a way as to cyclically check the quality of the cut. In particular, samples of the films are cyclically taken, the sides of which are checked by an operator using a microscope. However, spot checks require the commitment of an operator whose judgment on the quality of the cut is subjective. Moreover, the spot checks do not allow to intervene in a timely manner in the event of problems detected in the cutting operations.

To solve the problems deriving from spot checks, it has been proposed to perform an in-line optical check of the side of a film immediately after cutting. In particular, a camera is used that frames the side to acquire a series of digital images of the side and then these digital images are analyzed to check for the possible presence of metal burrs. However, known optical checking systems for a side of a film show unsatisfactory performance, as they are unable to combine effectiveness (i.e. the capability of identifying the faults while avoiding fake negatives) and efficiency (i.e. the capability of avoiding of fake positives).

More specifically, one of the problems in analyzing the digital images is determining the edges of the sides of the film, i.e. where the side of the film is located inside a digital image, as the two outer insulating layers have a very dark, almost black, color that tends to blend into the background that is substantially black.

Another problem of the analysis of the digital images is that a significant percentage of digital images are more or less blurred, as the microscopic optical system that is necessary to use so as to see very small objects (the film has an overall thickness typically less than a tenth of a millimeter) has a shallow depth of field and during its advancement the film is subjected to continuous small transversal movements (i.e. small movements towards or away from the microscopic optical system coupled to the camera).

Another problem of the analysis of the digital images, when the central metal layer is made of copper, is that the insulating material that constitutes the outer insulating layers has reddish grains that can very easily be confused with copper burrs or debris and therefore they can give rise to an improper detection of defects. A possible solution to this problem is not to identify as metal parts the red colored objects of relatively small size, in view of the fact that the reddish colored grains of the insulating material are quite small. However, in this way small copper burrs or debris are not recognized.

A further problem of the analysis of the digital images is that the film advances at a high speed (generally between 1 and 3 meters per second) and therefore to optically inspect the entire extension of the side of the film it is necessary both to use hardware (including the camera and the processing device that analyzes the digital images) which is very performing and therefore very expensive, and to perform an analysis of the digital images that is particularly fast and therefore inevitably less accurate and more prone to errors.

### DISCLOSURE OF THE INVENTION

The purpose of the present invention is to provide methods and optical checking units for a side of a film that allow to check the quality of the cut that generated the side in an effective (i.e. avoiding fake negatives) and efficient (i.e. avoiding fake positives) way.

According to the present invention, methods and optical checking units for a side of a film are provided, as claimed in the attached claims.

The claims describe embodiments of the present invention forming an integral part of the present description.

### BRIEF DESCRIPTION OF THE DRAWINGS

The present invention will now be described with reference to the attached drawings, which illustrate a non-limiting example of embodiment, in which:

FIG. 1 is a perspective view and with some parts removed for clarity of an optical checking unit of a side of a film in accordance with the present invention;

FIG. 2 is a perspective and exploded view of part of the optical checking unit of FIG. 1;

FIG. 3 is a plan view of part of the optical checking unit of FIG. 1;

FIG. 4 is a schematic view that highlights the illumination of the side of the film according to a preferred embodiment;

FIGS. 5 and 6 schematically show two different digital images acquired by the optical checking unit of FIG. 1 in the presence and absence of a backlighting of the film, respectively;

FIG. 7 is a schematic view of the optical checking unit of FIG. 1 which highlights a distance between an optical system of the camera and the side of the film; and

FIG. 8 schematically shows a digital image acquired by the optical checking unit of FIG. 1.

### BEST MODE FOR CARRYING OUT THE INVENTION

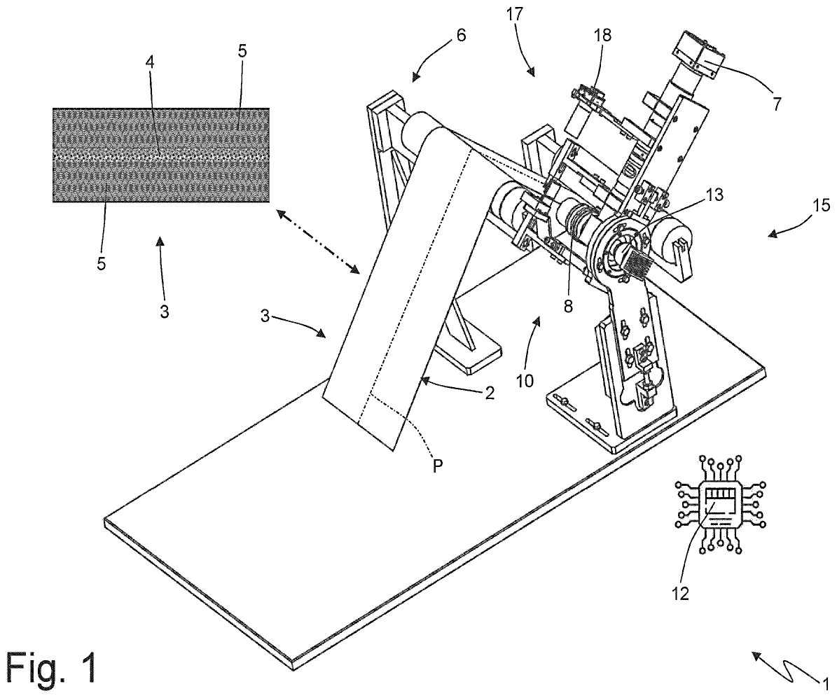

In FIG. 1, number 1 indicates as a whole an optical checking unit of a side 2 of a film 3.

The film 3 has a central metal layer 4 (i.e. a layer made of an electrically conductive material such as copper or aluminium) enclosed between two external insulating layers 5 (i.e. layers made of an electrically insulating material such as zinc oxide). The film 3 is used to make the electrodes of a battery and is made starting from a large metal sheet which is initially coated on both sides with insulating material and is subsequently cut into strips.

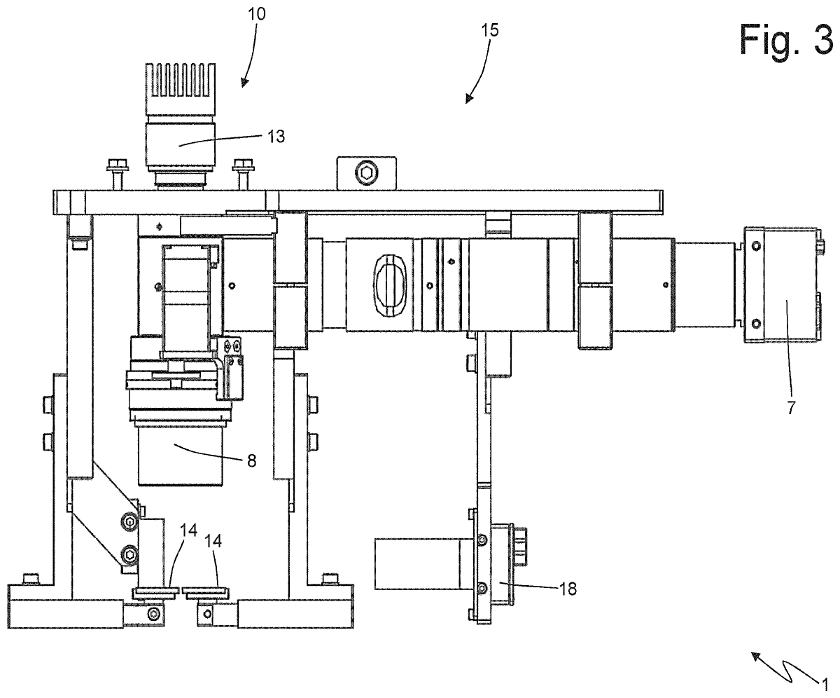

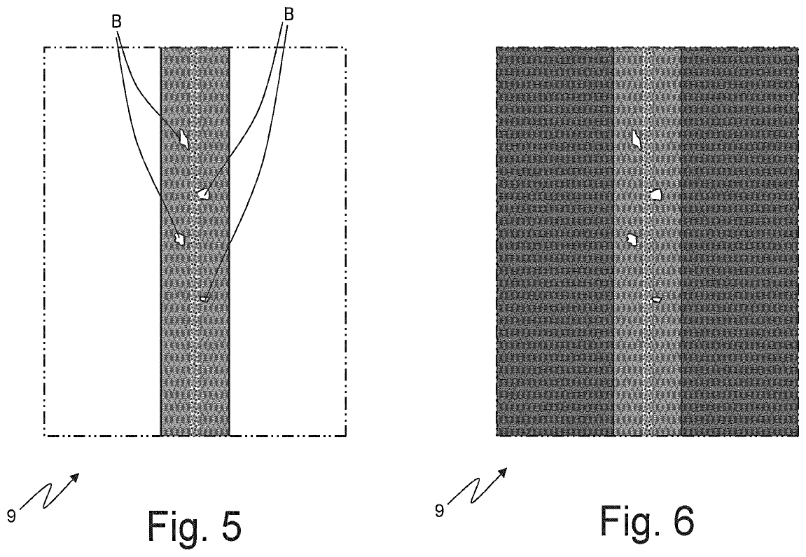

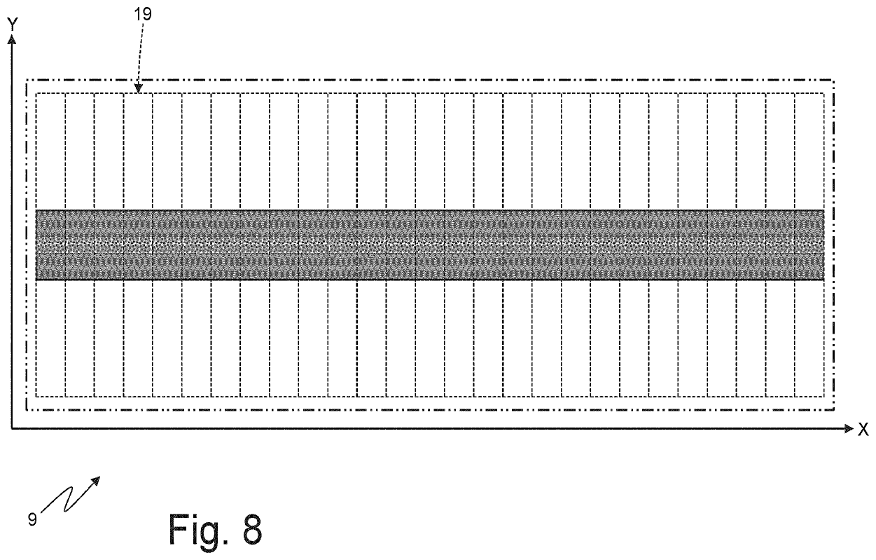

As illustrated in FIGS. 1, 2 and 3, the checking unit 1 comprises a conveyor 6 which advances the film 3 along a path P and a camera 7 which is arranged alongside the path P and is configured to frame through an optical system 8 the side 2 of the film 3 and acquire a succession of digital images 9 (illustrated in FIGS. 5, 6 and 8) of the side 2. Each digital image 9 has a rectangular shape and therefore, as illustrated in FIG. 8, has a longitudinal extension (along an axis X) parallel to the film 3 and a transverse extension (along an axis Y) perpendicular to the film 3. Moreover each digital image 9 is in color according to the RGB standard which provides that to each pixel of the digital image 9 corresponds a respective value of the red component, a respective value of the green component, and a respective value of the blue component (in particular, each value is stored in an 8-bit byte and varies between 0 and 255).

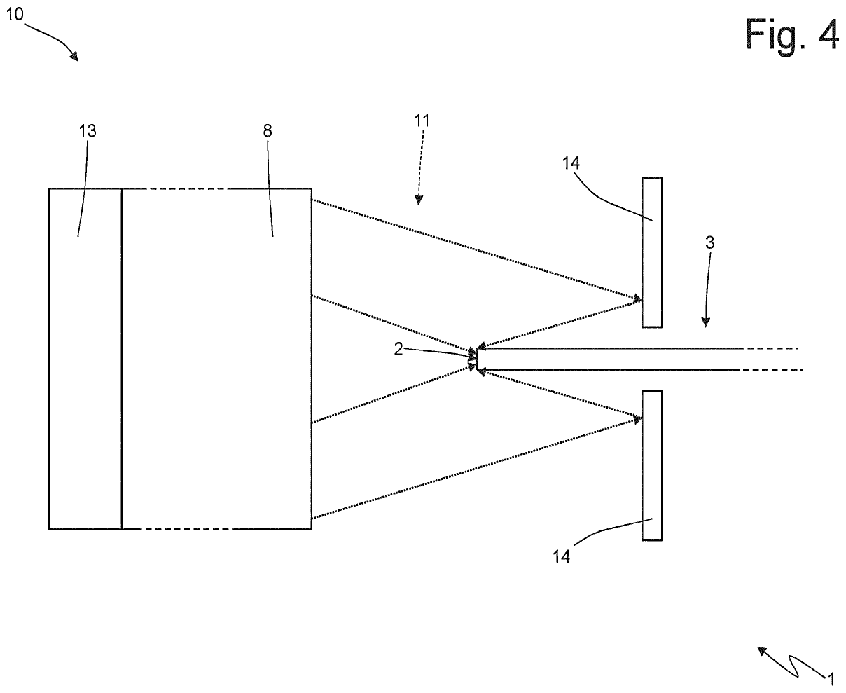

According to what is illustrated in FIG. 1, the checking unit 1 comprises (at least) a lighting device 10 which is configured to generate a light beam 11 (schematically illustrated in FIG. 4) intended to illuminate the film 3 (as better described hereinbelow).

The checking unit 1 comprises a processing device 12 (schematically illustrated in FIG. 1) which is connected to the camera 7 to drive the camera 7 and receive the digital images 9 from the camera 7.

As illustrated in FIG. 4, part of the light beam 11 generated by the lighting device 10 is directed by the optical system 8 towards the side 2 of the film 3 so as to directly illuminate the side 2 (direct illumination) while the remaining part of the light beam 11 generated by the lighting device 10 is directed towards the optical system 8 and illuminates an area surrounding the side 2 of the film 3 (backlight). In other words, part of the light beam 11 generated by the lighting device 10 is intended to make the surface of the side 2 of the film 3 more visible by providing a direct illumination of the side 2 and the remaining part of the light beam 11 generated by the lighting device 10 is intended to make an area surrounding the side 2 of the film 3 luminous, creating a backlight.

In particular, the part of the light beam 11 generated by the lighting device 10 and intended for the backlighting hits the film 3 at the edges of the side 2 along a direction directed towards the optical system 8, coming from the back of the side 2 with respect to the optical system 8.

The backlighting of the side 2 of the film 3 allows to considerably improve the recognition in the digital images 9 of the edges (borders) of the side 2, or the recognition within the digital images 9 of where the film 3, more specifically the side 2 of the film 3 is located. In fact, in the absence of adequate backlighting of the side 2, the two external insulating layers 5 have a very dark, almost black, color which tends to blend into the background which is substantially black. As an example, the two digital images 9 of FIGS. 5 and 6 show a digital image 9 in the presence of a proper backlighting of side 2 (FIG. 5) and a digital image 9 in the absence of backlighting of side 2 (in FIG. 6): the backlighting of side 2 makes the background behind side 2 very bright, substantially “white” in the digital images 9, so allowing to easily distinguish the edges of side 2.

As shown in FIG. 4, the lighting device 10 comprises an emitter 13 (preferably with white light LEDs) which is arranged on the same side of the optical system 8 with respect to the side 2 of the film 3 and is oriented towards the side 2 of the film 3. More specifically, the emitter 13 is arranged coaxially to the optical system 8 and emits the light beam 11 within the optical system 8 in such a way that the light beam 11 comes out from the optical system 8 coaxially to the optical system 8. Furthermore, the lighting device 10 comprises two reflecting elements 14 (i.e. two “mirrors”) which are arranged side by side on the opposite side of the optical system 8 with respect to the side 2 of the film 3 and are oriented towards the optical system 8 to reflect towards the side 2 part of the light beam 11 emitted by the emitter 13 (through the optical system 8). In particular, the two reflecting elements 14 are arranged side by side on opposite sides of the film 3, i.e. between the two reflecting elements 14 there is an empty space in which the film 3 is arranged. Consequently, the light beam 11 coming out of the optical system 8 partly directly illuminates the side 2 of the film 3 and is partly reflected by the reflecting elements 14 to create a backlight. Therefore the optical system 8 is configured to focus part of the light beam 11 emitted by the emitter 13 on the side 2 of the film 3 (direct illumination) and to focus the remaining part of the light beam 11 emitted by the emitter 13 on the reflecting elements 14 (backlight).

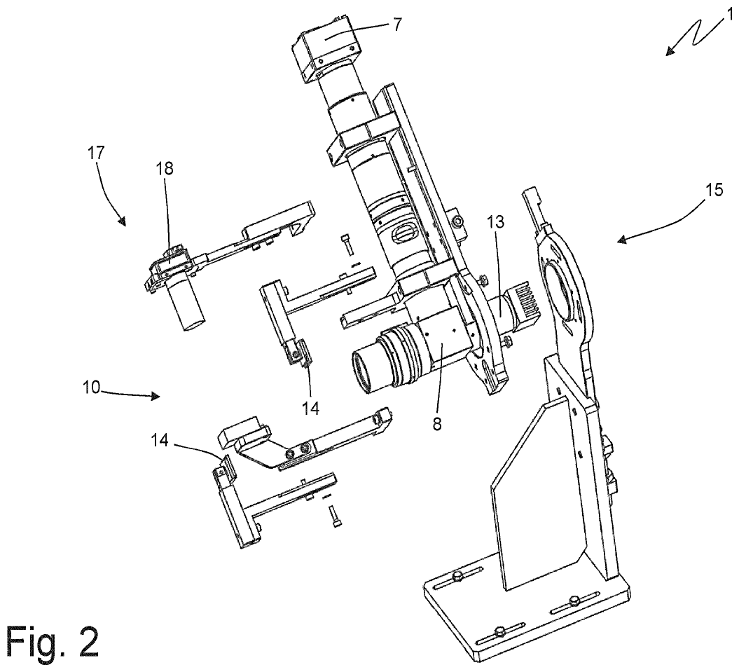

According to a possible embodiment illustrated in FIGS. 1-3, a single support structure 15 (also visible in FIG. 2) is provided which supports the camera 7, the optical system 8, the emitter 13 and the reflecting elements 14.

In the embodiment illustrated in the attached figures, the emitter 13 is arranged coaxially to the optical system 8 and the camera 7 is arranged perpendicular to the optical system 8 (i.e. the optical system 8 has a “T” shape).

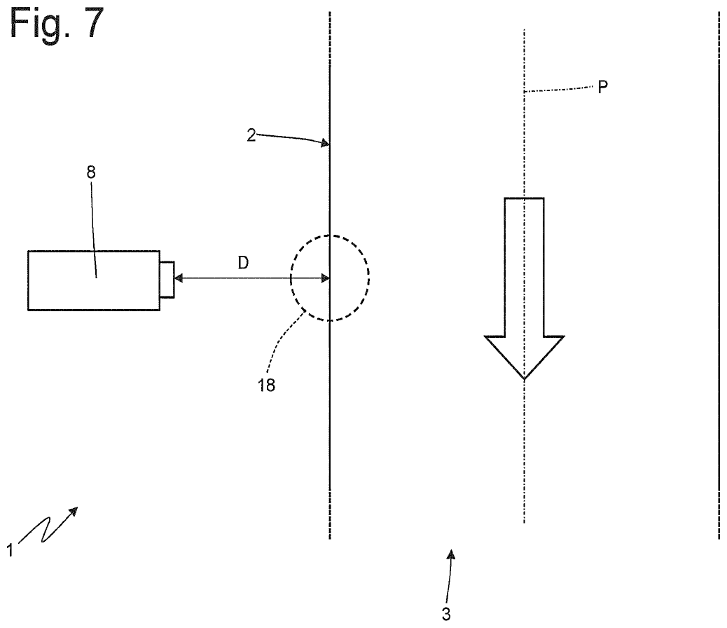

As illustrated in the attached figures, the checking unit 1 comprises a measuring device 17, supported by the support structure 15, which is configured to detect a change in a distance D (illustrated in FIG. 7) between the side 2 of the film 3 and the optical system 8 coupled to the camera 7. Moreover, the processing device 12 is configured to control actuation devices, for example an electric motor connected to the camera 7, to vary a focus of the camera 7 (by acting on the camera 7 and/or on the optical system 8) as a function of the change of the distance D between the side 2 of the film 3 and the optical system 8.

According to a preferred embodiment, the measuring device 17 comprises an additional camera 18 which is arranged alongside the path P and is configured to frame the side 2 of the film 3 and acquire a succession of further digital images of such side 2. In particular, the camera 7 frames the side 2 of the film 3 along a first direction (parallel to the film 3) and the additional camera 18 frames the side 2 of the film 3 along a second direction (perpendicular to the film 3) perpendicular to the first direction. Consequently, the processing device 12 is configured to analyze the additional digital images acquired by the additional camera 18 so as to recognize, within these additional digital images, the position of the side 2 of the film 3. By comparing the position of the side 2 of the film 3 in the succession of further digital images acquired by the additional camera 18 it is possible to determine if the side 2 of the film 3 remains in the same position (i.e. the distance D is constant), if the side 2 of the film 3 approaches the optical system 8 (i.e. the distance D decreases), or if the side 2 of the film 3 moves away from the optical system 8 (i.e. the distance D increases).

The additional camera 18 (unlike the camera 7) is preferably monochromatic, since it is used only to detect the transverse position of the side 2 of the film 3.

The optical system 8 which must be used to view very small objects (the film 3 has an overall thickness typically less than two tenths of a millimeter) is of the microscopic type and has a very limited depth of field. During its advancement the film 3 is subject to continuous small transverse movements, that is small movements towards or away from the microscopic optical system 8 coupled to the camera 7. In other words, since a sectioned film 3 having a thickness of around one tenth of a millimetre has to be analyzed and to recognize metal fragments or burrs a few microns large, a microscopic optical system 8 must be used which by its nature has a very limited depth of field, that is an acceptable focusing range of a few tens of microns. Thanks to the combined action of the measuring device 17 and the processing device 12 it is possible to continuously adjust the focus of the optical system 8 and/or of the camera 7 to substantially follow the continuous (accidental and unpredictable) variations of the distance D so that the digital images 9 acquired by the camera 7 are always in focus and therefore can be more easily analyzed and allow a more precise and accurate analysis.

As previously mentioned, the processing device 12 analyzes each digital image 9 to recognize within the digital image 9 pieces (burrs) of the central metallic layer 4 and in particular pieces (burrs) B of the central metal layer 4 unduly present inside the external insulating layers 5. The burrs B are shown, in FIGS. 5 and 6 only, in a schematic and not realistic layout, purely by way of example, while they are not shown, for simplicity, in FIGS. 1 and 8. During the transverse cut that separates the film 3 from the rest of the metal sheet, the blade that performs the cut can generate (particularly when such blade is worn) burrs B which extend from the central metal layer 4 into the outer insulating layers 5. The unwanted and dangerous presence of metal burrs B in the external insulating layers 5 can have very negative effects as these metal burrs can easily trigger short circuits in the battery between two adjacent electrodes. Such event, in addition to degrading the performance of the battery, can also cause destructive phenomena of the battery. So, within the digital images 9 it is necessary to recognize the pieces of the central metal layer 4 unduly present within the external insulating layers 5 in order to properly evaluate the defectiveness of the film 3.

As previously said, each digital image 9 is composed of a set of pixels to each of which corresponds a respective value of the red component, a respective value of the green component, and a respective value of the blue component. Each of said values is stored in an 8-bit byte and varies between 0 and 255.

The analysis of each digital image 9 performed by the processing device 12 allows to establish that a pixel represents a piece of the central metal layer 4 (i.e. it represents a piece of metal and not a piece of insulating material) only if the corresponding value of the red component lies within a first recognition interval, the corresponding value of the green component lies within a second recognition interval, and the corresponding value of the blue component lies within a third recognition interval.

Normally the three recognition intervals are different from each other, that is, they have different values. In particular, when the central metal layer 4 is made of copper, i.e. the metal that makes up the central metal layer 4 is copper, the first recognition interval relating to the red component has higher values than the other two intervals relating to the green and blue components. It is in fact evident that in the color of copper the red component prevails over the other component.

Copper has a characteristic red-orange color. As it is known, the first and most obvious reason why any object is colored is that the object absorbs some wavelengths of light and reflects other wavelengths of light: by looking at the intensity spectrum of copper light, when light is reflected on copper, copper atoms absorb some of the light in the blue-green region of the spectrum and as blue-green light is absorbed, its complementary color, the red-orange color, is reflected. The reflected light is also a function of the incident light and of the response of the camera 7 which passes through the optical system 8.

Considering the values of the three fundamental colors (red, green, blue) of the digital images 9 which are peculiar to the reflection on copper, it is possible to identify with certainty all the “copper pixels” and therefore not mistakenly identify as copper all the grains in the insulating layers that do not reflect in the same way as copper, also in case that they have a red color similar to the color of copper.

According to a preferred embodiment, a central value of each recognition interval is determined by theoretical assumptions, in particular it is determined as a function of the light absorption coefficient of the metal that makes up the central metal layer 4, as a function of the spectrum of the light beam 11 emitted by the lighting device 10, and as a function of the chromatic response of the camera 7. Furthermore, according to a preferred embodiment, the central value of each recognition interval is experimentally refined (or further determined) by detecting the values of the three color components in the digital images 9 of a sample film 3 having characteristics known a priori. Obviously it is also possible to determine the central value of each recognition interval only theoretically or, conversely, only experimentally, even though by combining the two methods the best results are obtained in the shortest time.

Similarly, an amplitude of each recognition interval can be determined theoretically and/or experimentally by detecting the values of the three color components in the digital images 9 of a sample film 3 having a priori known characteristics. Following the theoretical approach, the amplitude for each recognition interval (RGB) can be obtained by measuring the width at half height, or FWHM (Full Width At Half Maximum), relating to the distribution of the specific recognition interval. According to the experimental approach, the amplitude for each recognition interval can still be obtained using the FWHM, in this case associated with the histogram obtained by observing the sample film 3.

The insulating material of the external insulating layers 5 has reddish grains which can very easily be confused with copper burrs or debris. When the central metal layer 4 is made of copper, the detection of such reddish grains can mistakenly indicate the presence of non-existing defects (i.e. the false presence of metallic pieces of copper in the external insulating layers 5). Thanks to the simultaneous verification of the three color components, i.e. thanks to the fact that a pixel is recognized as representing a piece of the central metallic layer 4 only if at the same time the corresponding value of the red component is within the first recognition interval, the corresponding value of the green component is within the second recognition interval, and the corresponding value of the blue component is within the third recognition interval, it is possible to discern with extreme precision (i.e. with a modest percentage of error) between the metallic pieces of copper and the reddish grains of the insulating material.

According to a preferred embodiment illustrated in FIG. 8, in analyzing each digital image 9, the processing device 12 divides the digital image 9 into a succession of adjacent portions (sections, slices) 19, each having the same longitudinal dimension (along axis X), determines in each portion 19 the value of at least one qualitative parameter indicative of the quality of the film 3, and determines a summary value of the qualitative parameter for the entire digital image 9 by statistically processing the values of the qualitative parameter of all the portions 19 (in the simplest case by calculating an average of the values of the qualitative parameter of all portions 19). In other words, a processing is carried out section by section (the sections corresponding to the portions 19 into which the same digital image 9 is divided) and the final result of processing all the sections (portions 19) of a digital image 9 is a unique summary value which gives a “statistical” indication of the quality.

According to a preferred, but not binding, embodiment, each digital image 9 is normally divided into a number of adjacent portions 19 comprised between 60 and 120 and each portion 19 has a longitudinal extension equal to 8-12 pixels.

As previously mentioned, within the digital images 9 it is necessary to recognize pieces (burrs) of the central metal layer 4 and in particular pieces (burrs) B of the central metal layer 4 which are unduly located inside the external insulating layers 5 (i.e. the presence of burrs B originating from the central metal layer 4) to evaluate the defectiveness of the film 3. Consequently, a first qualitative parameter that can be determined by the processing device 12 during the analysis of the digital images 9 is determined as a function of an area of possible burrs originating from the central metal layer 4 (i.e. of any metal pieces that are unduly located inside the external insulating layers 5). That is, the first qualitative parameter is determined as a function of an area in the digital image 9 of any burrs B originating from the central metal layer 4, i.e. if in the digital image 9 the pixels representing a burr B coming from the central metal layer 4 are more extended or less extended. A second qualitative parameter that can be determined by the processing device 12 during the analysis of the digital images 9 is a distance from a center of the central metal layer 4 of possible burrs B originated by the central metal layer 4 (i.e. if any burrs originated by the central metallic layer 4 are more or less distant from the center of the central metal layer 4).

In fact, to establish the level of defectiveness of the film 3 it is necessary to evaluate both the extension of possible metal burrs B present in the external insulating layers 5 (the larger the burrs B, the more dangerous they are for the integrity of the battery), and the distance of possible metal burrs B present in the outer insulating layers 5 coming from the central metal layer 4, that is the proximity of any metal burrs B to the outer surface of the film 3 (the farther the burrs B are from the central metal layer 4, the more dangerous they are for the battery integrity).

According to a preferred embodiment, the area of any burrs B recognized in a digital image 9 is normalized with respect to the area of the side 2, i.e. it is expressed as a function of the area of the side 2 in such a way as to have an indication on the area of any burrs B which is independent of the scale factor of the digital image 9.

According to a preferred embodiment, the digital images 9 of the side 2 of the film 3 are acquired at a certain distance from each other in such a way that the digital images 9 of the side 2 of the film 3 cover, altogether, a limited portion of the extension of the side 2 of the film 3, for example 5-15% of the entire extension. This operating mode on the one hand allows to enormously reduce the complexity (therefore the cost) of the hardware as an extremely high acquisition speed and processing speed are not necessary, and on the other hand it guarantees not to lose significant information on the real defectiveness of the film 3 since the actual defectiveness of the film 3 never presents sudden peaks but only a slow drift (with times of the order of hours) due to the progressive wear of the blades that perform the cutting of the film 3.

Summarizing what has been described above, the checking unit 1 acquires, by means of the “microscopic” optical system 8, a series of digital images 9 of the side 2 of the film 3 (that is of the section of the film 3 that has just been cut) to check its quality while the film 3 flows at high speed. The result of the inspection can be used to analyze the quality of the film 3 itself and/or of the cutting process.

According to a preferred embodiment, the camera 7 is a linear camera (instead of a more traditional matrix camera) which acquires a digital image consisting of a single line of pixels at each scan. The final (complete) digital image 9 is constructed a posteriori by making use of the relative movement between the film 3 and the camera 7 and joining a plurality of digital images consisting of a single line of pixels. In fact, it has been observed that in this application the use of a linear camera allows for better results than the use of a more traditional matrix camera.

The embodiments herein described can be combined with each other without departing from the scope of protection of the present invention.

The above described checking unit 1 has numerous advantages.

First, the above described checking unit 1 allows to check the quality of the cut that generated the side in an effective (i.e. avoiding fake negatives) and efficient (i.e. avoiding fake positives) way.

In addition, the above described checking unit 1 allows to evaluate the increase over time of the defectiveness of the film 3, such increase being directly correlated to the progressive wear of the blades that perform the cutting of the film 3. In this way it is possible to predict well in advance when it will be necessary to change the blades in order to maintain the desired quality, that is it is possible to carry out an effective predictive maintenance of the blades.

Finally, the above described checking unit 1 has a relatively low production cost as it uses only commercially available components and does not require particularly high processing capacities (powers).

1. Optical checking unit for checking a side of a film which advances along a path, the checking unit includes:
a camera which is arranged next to the path and is configured to frame the side of the film through an optical system and acquire a sequence of digital images of the side; and
at least one lighting device comprising an emitter configured to generate a light beam, the emitter being arranged on the same side of the optical system with respect to the side of the film and oriented towards the side of the film;
wherein the lighting device further comprises at least one reflecting element which is arranged on the opposite side of the optical system with respect to the side of the film and is oriented towards the optical system to reflect towards the side part of the light beam emitted by the emitter and illuminate an area surrounding the side of the film.

2. Checking unit according to claim 1, wherein the lighting device comprises two reflecting elements which are arranged side by side on opposite sides of the film.

3. Checking unit according to claim 1, wherein the emitter emits the light beam within the optical system in such a way that the light beam comes out of the optical system coaxially to the optical system.

4. Checking unit according to claim 3, wherein the light beam coming out of the optical system partly directly illuminates the side of the film and partly is reflected by the reflective element.

5. (canceled)

6. Checking unit according to claim 3, wherein the emitter is arranged coaxially to the optical system and the camera is arranged perpendicular to the optical system.

7. Optical checking method for checking a side of a film; the checking method includes the steps of:
advancing the film along a path,
acquiring a sequence of digital images of the side of the film by means of a camera which is arranged next to the path to frame the side through an optical system; and
generating at least one light beam by means of a lighting device, the light beam coming out of the optical system coaxially to the optical system and partly directly illuminating the side of the film;
wherein the light beam generated by the lighting device is partly reflected by a reflecting element arranged on the opposite side of the optical system with respect to the side of the film and oriented towards the optical system and illuminates an area surrounding the side of the film.

8. Optical checking method for checking a side of a film featuring a central metal layer and two insulating external layers; the checking method includes the steps of:
advancing the film along a path;
generating at least one light beam which illuminates the film by means of a lighting device;
acquiring a sequence of digital images of the side of the film by means of a camera which is placed next to the path to frame the side through an optical system; and
analyzing each digital image to spot pieces of the central metal layer within said digital image;
each digital image being in color and composed of a set of pixels to each of which corresponds a respective value of the red component, a respective value of the green component, and a respective value of the blue component;
wherein the analysis of each digital image comprises the further step of establishing that a pixel represents one of said pieces of the central metal layer only in case that the corresponding value of the red component is comprised in a first recognition interval, the corresponding value of the green component is comprised in a second recognition interval, and the corresponding value of the blue component is comprised in a third recognition interval.

9. Checking method according to claim 8, wherein the three recognition intervals are different from each other.

10. Checking method according to claim 8, wherein a central value of each recognition interval is determined as a function of the light absorption coefficient of the metal composing the central metal layer, as a function of the spectrum of the light beam emitted by the lighting device, and as a function of the chromatic response of the camera.

11. Checking method according to claim 8, wherein a central value of each recognition interval is experimentally determined by detecting the values of the three color components in the digital images of a sample film having features known a priori.

12. Checking method according to claim 8, wherein an amplitude of each recognition interval is experimentally determined by detecting the values of the three color components in the digital images of a sample film having features known a priori.

13. (canceled)

14. (canceled)

15. Optical checking method for checking a side of a film featuring a central metal layer and two insulating external layers; the checking method includes the steps of:
advancing the film along a path;
generating at least one light beam which illuminates the film by means of a lighting device;
acquiring a sequence of digital images of the side of the film by means of a camera which is arranged next to the path to frame the side through an optical system; and
analyzing each digital image;
each digital image having a longitudinal extension parallel to the film and a transversal extension perpendicular to the film;
wherein the analysis of each digital image includes the further steps of:
dividing the digital image into a sequence of adjacent portions each having the same longitudinal dimension;
determining in each portion the value of at least one qualitative parameter indicative of the quality of the film; and
determining a summary value of the qualitative parameter for the entire digital image by statistically processing the values of the qualitative parameter of all the portions.

16. (canceled)

17. (canceled)

18. Checking method according to claim 15, wherein a first qualitative parameter is determined as a function of an area of possible burrs originated by the central metal layer.

19. Checking method according to claim 15, wherein a second qualitative parameter is a distance from a center of the central metal layer of possible burrs originated by the central metal layer.

20. Checking method according to claim 15, wherein the digital images of the side of the film are acquired at a certain distance from each other and cover as a whole a limited portion of the extension of the side of the film.

21. (canceled)

22. Checking method according to claim 15, wherein the summary value of the qualitative parameter for the entire digital image is determined by calculating an average of the values of the qualitative parameter of all portions.

23. (canceled)

24. Checking unit according to claim 1 further including a measuring device which is configured to detect a change in a distance between the side of the film and the optical system; and
a processing device which is configured to control a drive device for varying a focus of the camera as a function of the change in the distance between the side of the film and the optical system.

25. Checking unit according to claim 24, wherein the measuring device comprises an additional camera which is arranged next to the path and is configured to frame the side of the film and acquire a sequence of further digital images of the side.

26. Checking unit according to claim 25, wherein the camera frames the side of the film along a first direction parallel to the film and the additional camera frames the side of the film along a second direction perpendicular to the first direction.

27. (canceled)

28. (canceled)

29. Checking method according to claim 7 including the further steps of:
detecting, by means of a measuring device, a change in a distance between the side of the film and the optical system; and
varying, by means of a drive device controlled by a processing device, a focus of the camera as a function of the change in the distance between the side of the film and the optical system.

30. (canceled)
